(19) United States
(12) Patent Application Publication
(10) Pub. No.: US 2025/0115268 A1
(43) Pub. Date: Apr. 10, 2025

(54) DRIVING ASSISTANCE APPARATUS, DRIVING ASSISTANCE METHOD, AND RECORDING MEDIUM

(71) Applicant: HONDA MOTOR CO., LTD., Tokyo (JP)

(72) Inventors: Naotoshi Fujimoto, Wako-shi (JP); Seiji Kobata, Wako-shi (JP); Takashi Oshima, Wako-shi (JP)

(21) Appl. No.: 18/893,398

(22) Filed: Sep. 23, 2024

(30) Foreign Application Priority Data
Oct. 6, 2023 (JP) 2023-174237

(51) Int. Cl. B60W 50/16; B60W 30/095; B60W 40/08; B60W 50/14; G06V 20/58; G06V 20/59; G06V 40/18

(52) U.S. Cl. CPC B60W 50/16; B60W 30/0956; B60W 40/08; G06V 20/58; G06V 20/597; G06V 40/18; B60W 2050/143; B60W 2050/146; B60W 2420/403; B60W 2540/221; B60W 2540/225; B60W 2540/229; B60W 2554/4041; B60W 2556/50

(57) ABSTRACT

A driving assistance apparatus includes: a controlled vehicle movement information acquisition unit acquiring controlled vehicle movement information; a surrounding object movement information acquisition unit acquiring surrounding object movement information; a risk occurrence time point prediction unit predicting a risk occurrence time point at which a predetermined risk occurs due to approaching of the controlled vehicle and the surrounding object, based on the controlled vehicle movement information and the surrounding object movement information; a driver state recognition unit recognizing a state of a driver of the controlled vehicle; and a calling attention control unit determining execution timing of calling attention and contents of the calling attention, based on a remaining time until the risk occurrence time point and the state of the driver recognized by the driver state recognition unit.

### INCORPORATION BY REFERENCE

The present application claims priority under 35 U.S.C. § 119 to Japanese Patent Application No. 2023-174237 filed on Oct. 6, 2023. The content of the application is incorporated herein by reference in its entirety.

### BACKGROUND

### Technical Field

The present invention relates to a driving assistance apparatus, a driving assistance method, and a recording medium.

### Related Art

Conventionally, there has been proposed an in-vehicle peripheral situation presentation device that calculates a blind spot where a monitoring range of a camera and a radar device provided in a self-vehicle cannot be monitored because of being shaded by another vehicle, and displays the blind spot on a map image to call attention to a driver (see, for example, JP 2007-233770 A).

### SUMMARY

Incidentally, the above-described conventional device calls attention to the driver according to a surrounding situation of the self-vehicle detected by the camera and the radar device provided in the self-vehicle. Therefore, when the behavior of another vehicle or a pedestrian moving around the self-vehicle is not recognized on the self-vehicle side, calling attention to the driver may not be performed at appropriate timing.

In order to solve the above problem, an object of the present application is to improve safety by providing a driving assistance apparatus, a driving assistance method, and a program capable of performing calling attention of a driver to an object present around a self-vehicle at appropriate timing with appropriate contents. In addition, such an object is to further improve traffic safety and contribute to development of a sustainable transportation system.

A first aspect for achieving the above object is a driving assistance apparatus. The driving assistance apparatus includes: a controlled vehicle movement information acquisition unit configured to acquire controlled vehicle movement information including position information of a controlled vehicle; a surrounding object movement information acquisition unit configured to acquire surrounding object movement information including position information of a surrounding object present around the controlled vehicle; a risk occurrence time point prediction unit configured to predict a risk occurrence time point at which a predetermined risk occurs due to approaching of the controlled vehicle and the surrounding object, based on the controlled vehicle movement information and the surrounding object movement information; a driver state recognition unit configured to recognize a state of a driver of the controlled vehicle; and a calling attention control unit configured to determine execution timing of calling attention by a notification device provided in the controlled vehicle and contents of the calling attention, based on a remaining time until the risk occurrence time point and the state of the driver recognized by the driver state recognition unit.

In the driving assistance apparatus, the driver state recognition unit may recognize a direction of a line of sight of the driver as the state of the driver, the surrounding object movement information may include information indicating whether or not the controlled vehicle is recognized in the surrounding object, and the calling attention control unit may execute the calling attention when it is determined that the controlled vehicle is not recognized in the surrounding object based on the surrounding object movement information, even in a case where it is recognized by the driver state recognition unit that the line of sight of the driver is directed to the surrounding object.

In the driving assistance apparatus, the calling attention control unit may increase a level of the calling attention as the remaining time until the predetermined risk occurrence time point decreases.

In the driving assistance apparatus, the driver state recognition unit may recognize a driving state of the controlled vehicle by the driver as the state of the driver, and the calling attention control unit may not execute the calling attention when it is determined that the driver is capable of avoiding the predetermined risk from the driving state of the controlled vehicle by the driver recognized by the driver state recognition unit.

In the driving assistance apparatus, the driver state recognition unit may recognize a health state of the driver and the direction of the line of sight of the driver, and when it is recognized by the driver state recognition unit that the line of sight of the driver is directed to the surrounding object, the calling attention control unit may determine whether or not to perform the calling attention according to the health state of the driver recognized by the driver state recognition unit.

A second aspect for achieving the above object is a driving assistance method executed by a computer. The driving assistance method includes: a controlled vehicle movement information acquisition step of acquiring controlled vehicle movement information including position information of a controlled vehicle; a surrounding object movement information acquisition step of acquiring surrounding object movement information including position information of a surrounding object present around the controlled vehicle; a risk occurrence time point prediction step of predicting a risk occurrence time point at which a predetermined risk occurs due to approaching of the controlled vehicle and the surrounding object, based on the controlled vehicle movement information and the surrounding object movement information; a driver state recognition step of recognizing a state of a driver of the controlled vehicle; and a calling attention control step of determining execution timing of calling attention by a notification device provided in the controlled vehicle and contents of the calling attention, based on a remaining time until the risk occurrence time point and the state of the driver recognized by the driver state recognition step.

A third aspect for achieving the above object is a non-transitory recording medium storing a program that causes a computer to function as: a controlled vehicle movement information acquisition unit configured to acquire controlled vehicle movement information including position information of a controlled vehicle; a surrounding object movement information acquisition unit configured to acquire surrounding object movement information including position information of a surrounding object present around the controlled vehicle; a risk occurrence time point prediction unit configured to predict a risk occurrence time point at which a predetermined risk occurs due to approaching of the controlled vehicle and the surrounding object, based on the controlled vehicle movement information and the surrounding object movement information; a driver state recognition unit configured to recognize a state of a driver of the controlled vehicle; and a calling attention control unit configured to determine execution timing of calling attention by a notification device provided in the controlled vehicle and contents of the calling attention, based on a remaining time until the risk occurrence time point and the state of the driver recognized by the driver state recognition unit.

According to the driving assistance apparatus, it is possible to perform calling attention of a driver to an object present around a self-vehicle at appropriate timing with appropriate contents.

### BRIEF DESCRIPTION OF DRAWINGS

FIG. 1 is a configuration diagram of a vehicle on which a driving assistance apparatus is mounted;

FIG. 2 is a configuration diagram of the driving assistance apparatus;

FIG. 3 is a first flowchart of driving assistance processing;

FIG. 4 is a second flowchart of the driving assistance processing;

FIG. 5 is a third flowchart of the driving assistance processing;

FIG. 6 is an explanatory diagram of driving assistance processing in a situation where a self-vehicle turns right at an intersection;

FIG. 7 is an explanatory diagram of execution timing of calling attention corresponding to turning right at the intersection and contents of the calling attention;

FIG. 8 is an explanatory diagram of an execution situation of calling attention corresponding to turning right at the intersection; and

FIG. 9 is an explanatory diagram of execution timing of calling attention corresponding to traveling on a priority road and contents of the calling attention.

### DETAILED DESCRIPTION

### 1. Configuration of Vehicle

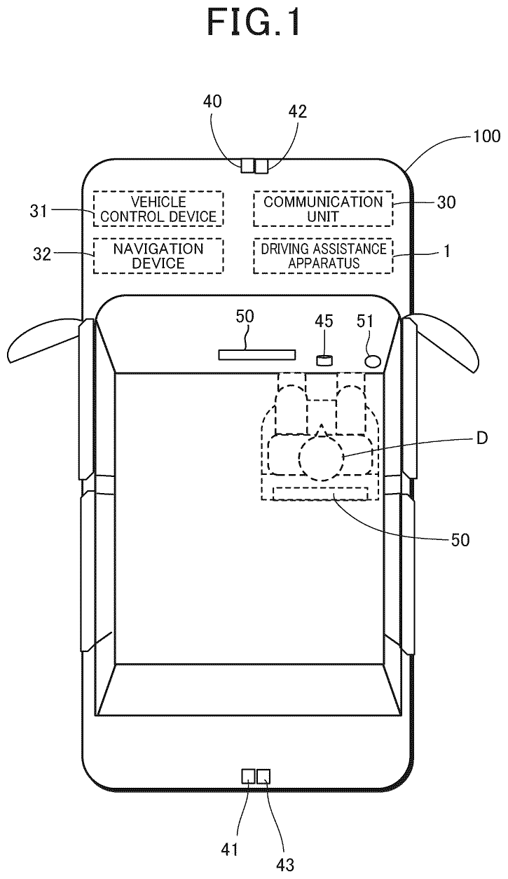

A configuration of a controlled vehicle 100 on which a driving assistance apparatus 1 of the present embodiment is mounted will be described with reference to FIG. 1. The controlled vehicle 100 is a four-wheeled vehicle, and hereinafter, the controlled vehicle 100 is referred to as a self-vehicle 100.

A front camera 40 that captures an image of the front of the self-vehicle 100 and a front radar 42 that detects a position of an object present in front of the self-vehicle 100 are provided in a front portion of the self-vehicle 100. A rear camera 41 that captures an image of the rear of the self-vehicle 100 and a rear radar 43 that detects a position of an object present behind the self-vehicle 100 are provided in a rear portion of the self-vehicle 100.

A display 50, a speaker 51, and a seat vibration device 52 corresponding to a notification device of the present disclosure, and a driver's seat camera 45 that captures an image of a driver D are provided in the vehicle interior of the self-vehicle 100. Further, a communication unit 30, a vehicle control device 31, and a navigation device 32 are provided in the self-vehicle 100.

The communication unit 30 communicates with a server or the like outside the self-vehicle 100. The vehicle control device 31 controls the operation of the self-vehicle 100. The navigation device 32 includes a global navigation satellite system (GNSS) sensor 33 that detects the position of the self-vehicle 1 by receiving radio waves transmitted from a plurality of navigation satellites toward the ground, and map data 34, and executes route guidance to a destination or the like.

### 2. Configuration of Driving Assistance Apparatus

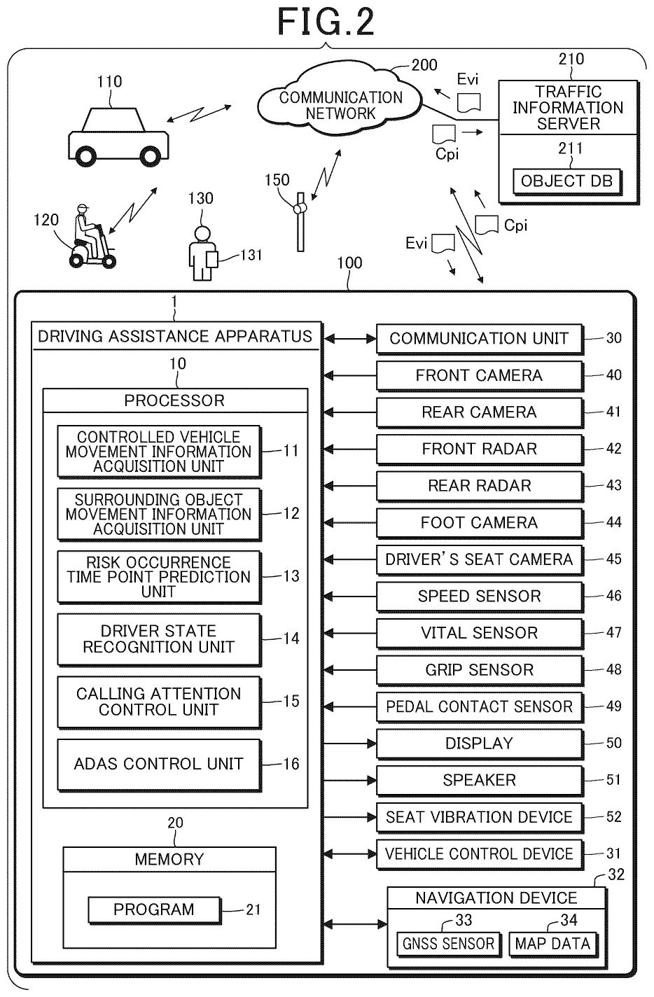

A configuration of the driving assistance apparatus 1 will be described with reference to FIG. 2. The driving assistance apparatus 1 is a control unit including a processor 10, a memory 20, an interface circuit (not illustrated), and the like.

The driving assistance apparatus 1 is connected to a front camera 40, a rear camera 41, a front radar 42, a foot camera 44, a driver's seat camera 45, a speed sensor 46, a vital sensor 47, a grip sensor 48, a pedal contact sensor 49, a display 50, a speaker 51, a seat vibration device 52, a vehicle control device 31, and a navigation device 32 provided in the self-vehicle 100.

The foot camera 44 captures an image of the foot of the driver D (see FIG. 1), and inputs a captured image of an operation situation of a brake pedal and an accelerator pedal by the driver D to the driving assistance apparatus 1. The driver's seat camera 45 captures an image of a face of the driver D and inputs the captured image to the driving assistance apparatus 1. The speed sensor 46 detects a traveling speed of the self-vehicle 100 and inputs a speed detection signal to the driving assistance apparatus 1. The vital sensor 47 detects biological information (heart rate, pulse wave, body temperature, blood pressure, respiration rate, and the like) of the driver D, and inputs a detection signal to the driving assistance apparatus 1.

The grip sensor 48 detects a grip situation of a steering wheel by the driver D and inputs a detection signal to the driving assistance apparatus 1. The pedal contact sensor 49 detects that the foot of the driver D touches the brake pedal, and inputs a detection signal to the driving assistance apparatus 1. The display 50 displays various types of information according to a control signal input from the driving assistance apparatus 1. The display 50 is, for example, a flat panel display such as a liquid crystal display or an organic EL display. Note that the display 50 may be a head-up display (HUD). The speaker 51 amplifies and outputs a sound signal output from the driving assistance apparatus 1.

The seat vibration device 52 is attached to the driver's seat and vibrates according to a control signal input from the driving assistance apparatus 1 to call attention to the driver D. The vehicle control device 31 executes control of driving assistance by an advanced driving assistant system (ADAS) based on the images captured by the front camera 40 and the rear camera 41 and the position detection signals of the front radar 42 and the rear radar 43. The ADAS includes a collision reduction brake, a pedestrian accident reduction steering, and the like.

The driving assistance apparatus 1 communicates with a traffic information server 210 via a communication network 200 by the communication unit 30. The traffic information server 210 receives movement information (including a position, a speed, a driving situation, and the like) transmitted from a large number of vehicles and mobile terminals registered in the traffic information server 210 in real time and records the movement information in an object database (DB) 211. FIG. 2 illustrates an example in which the traffic information server 210 receives movement information transmitted from a four-wheeled vehicle 110, a two-wheeled vehicle 120, and a mobile terminal 131 (a smartphone, a mobile phone, a tablet terminal, and the like) of a pedestrian 130. The four-wheeled vehicle 110, the two-wheeled vehicle 120, and the pedestrian 130 correspond to surrounding objects of the present disclosure.

In addition, the traffic information server 210 receives and acquires a captured image transmitted from a monitor camera 150 installed on a roadside or the like, analyzes the captured image, recognizes an object present in the vicinity of an installation place of the monitor camera 150, and records information of the recognized object in the object DB 211.

The processor 10 reads and executes a program 21 stored in the memory 20, thereby functioning as a controlled vehicle movement information acquisition unit 11, a surrounding object movement information acquisition unit 12, a risk occurrence time point prediction unit 13, a driver state recognition unit 14, a calling attention control unit 15, and an ADAS control unit 16. The program 21 may be read from a recording medium (for example, an optical disc or a flash memory) by the driving assistance apparatus 1 and stored in the memory 20, or may be downloaded by the driving assistance apparatus 1 from an external server (not shown) or the like and stored in the memory 20.

Processing executed by the controlled vehicle movement information acquisition unit 11 corresponds to a controlled vehicle movement information acquisition step in a driving assistance method of the present disclosure, and processing executed by the surrounding object movement information acquisition unit 12 corresponds to a surrounding object movement information acquisition step in the driving assistance method of the present disclosure. Processing executed by the risk occurrence time point prediction unit 13 corresponds to a risk occurrence time point prediction step in the driving assistance method of the present disclosure, and processing executed by the driver state recognition unit 14 corresponds to a driving state recognition step in the driving assistance method of the present disclosure. Processing executed by the calling attention control unit 15 corresponds to a calling attention control step in the driving assistance method of the present disclosure.

The controlled vehicle movement information acquisition unit 11 acquires controlled vehicle movement information including the position of the self-vehicle 100 detected by the GNSS sensor 33 and the speed of the self-vehicle 100 detected by the speed sensor 46. The surrounding object movement information acquisition unit 12 transmits self-vehicle position information Cpi indicating the position of the self-vehicle 100 to the traffic information server 210, and requests transmission of surrounding object movement information Evi including the position and the speed of the object (surrounding object) present around the self-vehicle 100, thereby acquiring the surrounding object movement information Evi. Note that, in a case where the speed of the object is calculated by a change in the position of the object, it is not necessary to include the speed in the surrounding object movement information Evi.

The risk occurrence time point prediction unit 13 determines the possibility of occurrence of a predetermined risk (sudden stop, contact, or the like) due to approaching of the self-vehicle 100 and the surrounding object based on the controlled vehicle movement information, the surrounding object movement information, and the map data 34, and predicts the occurrence time point of the predetermined risk (risk occurrence time point) when there is the possibility of occurrence of the predetermined risk.

The driver state recognition unit 14 recognizes the driving state of the self-vehicle 100 by the driver D based on the image captured by the foot camera 44, the image captured by the driver's seat camera 45, the detection signal of the grip sensor 48, and the detection signal of the pedal contact sensor 49. In addition, the driver state recognition unit 14 recognizes the health state of the driver D based on the image captured by the driver's seat camera 45 and the detection signal of the vital sensor 47.

When the occurrence of the predetermined risk is recognized by the risk occurrence time point prediction unit 13 and the risk occurrence time point is predicted, the calling attention control unit 15 determines execution timing of calling attention to the driver D and contents of the calling attention, based on the remaining time until the risk occurrence time point, the driving state of the driver D, the health state of the driver D, the state of the surrounding object, and the like. The ADAS control unit 16 executes control of the ADAS by outputting a control signal to the vehicle control device 31.

### 3. Calling Attention Processing

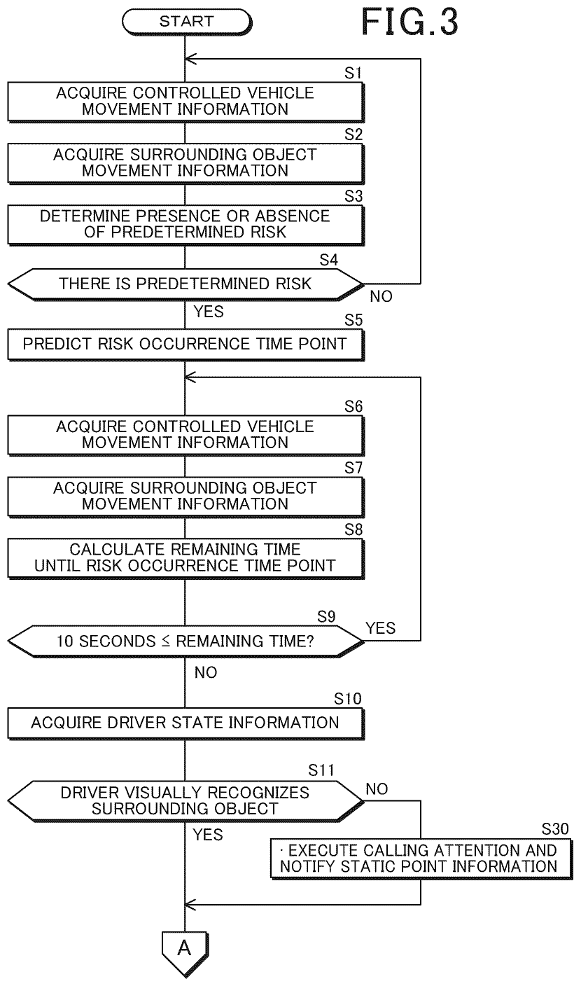

An execution procedure of calling attention processing executed by the driving assistance apparatus 1 will be described with reference to flowcharts illustrated in FIGS. 3 to 5.

In step S1 of FIG. 3, the controlled vehicle movement information acquisition unit 11 acquires controlled vehicle movement information from the detection signal of the GNSS sensor 33, the detection signal of the speed sensor 46, and the map data 34. In subsequent step S2, the surrounding object movement information acquisition unit 12 accesses the traffic information server 210 to acquire surrounding object movement information regarding a surrounding object present around the self-vehicle 100.

In subsequent step S3, the risk occurrence time point prediction unit 13 determines the presence or absence of a predetermined risk that may occur due to approaching of the self-vehicle 100 and the surrounding object, based on the controlled vehicle movement information and the surrounding object movement information. In subsequent step S4, the risk occurrence time point prediction unit 13 advances the processing to step S5 in a case where there is the predetermined risk, and advances the processing to step S1 in a case where there is no predetermined risk.

In step S5, the risk occurrence time point prediction unit 13 predicts a risk occurrence time point at which the self-vehicle 100 and the surrounding object come into contact with each other, based on the position and the speed of the self-vehicle 100 recognized from the controlled vehicle movement information and the position and the speed of the surrounding object recognized from the surrounding object movement information. In subsequent step S6, the controlled vehicle movement information acquisition unit 11 acquires the controlled vehicle movement information, and in step S7, the surrounding object movement information acquisition unit 12 acquires the surrounding object movement information.

In subsequent step S8, the calling attention control unit 15 calculates a remaining time until the risk occurrence time point, based on the controlled vehicle movement information and the surrounding object movement information. In subsequent step S9, the calling attention control unit 15 determines whether or not the remaining time until the risk occurrence time point is 10 seconds or more. When the remaining time is 10 seconds or more, the calling attention control unit 15 advances the processing to step S6, and when the remaining time is less than 10 seconds, the calling attention control unit 15 advances the processing to step S10.

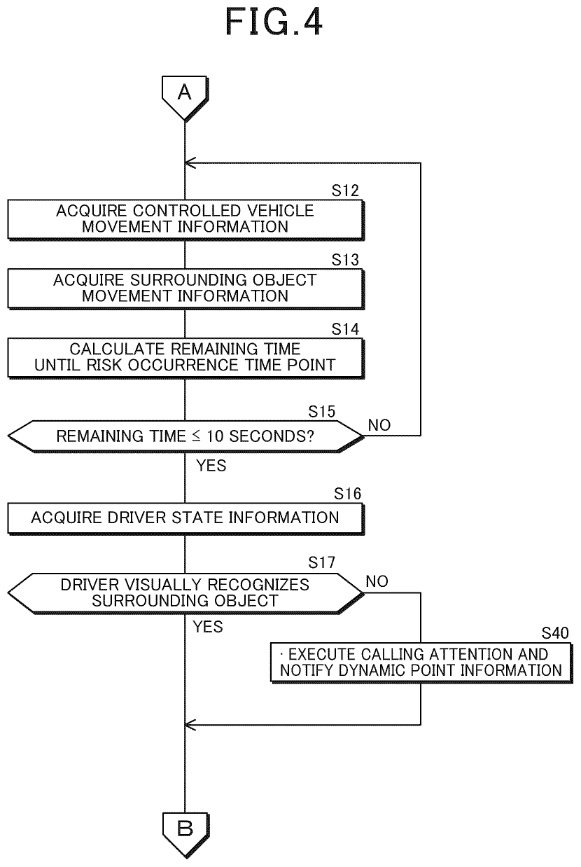

In step S10, the driver state recognition unit 14 acquires driver state information. Here, the driver state recognition unit 14 recognizes a direction of a line of sight of the driver D from the captured image of the driver D by the driver's seat camera 45. In subsequent step S11, the calling attention control unit 15 determines whether or not the driver D visually recognizes the surrounding object from the direction of the line of sight of the driver D. When the driver D visually recognizes the surrounding object, the calling attention control unit 15 advances the processing to step S12 in FIG. 4, and in this case, the calling attention is not performed.

On the other hand, when the driver D does not visually recognize the surrounding object, the calling attention control unit 15 advances the processing to step S30, executes the calling attention for notifying static point information (such as turning right at an intersection to be described later), and advances the processing to step S12 in FIG. 4. Specifically, the calling attention control unit 15 calls attention to the driver D by displaying the calling attention by the display 50, outputting a calling attention sound from the speaker 51, and operating the seat vibration device 52. Note that the calling attention to the driver D may be performed by any one or two of the display of the calling attention by the display 50, the output of the calling attention sound from the speaker 51, and the operation of the seat vibration device 52.

In step S12 of FIG. 4, the controlled vehicle movement information acquisition unit 11 acquires the controlled vehicle movement information, and in step S13, the surrounding object movement information acquisition unit 12 acquires the surrounding object movement information. In subsequent step S14, the calling attention control unit 15 calculates the remaining time until the risk occurrence time point based on the controlled vehicle movement information and the surrounding object movement information. In subsequent step S15, the calling attention control unit 15 determines whether or not the remaining time until the risk occurrence time point is less than 10 seconds. When the remaining time is less than 10 seconds, the calling attention control unit 15 advances the processing to step S16, and when the remaining time is 10 seconds or more, the calling attention control unit 15 advances the processing to step S12.

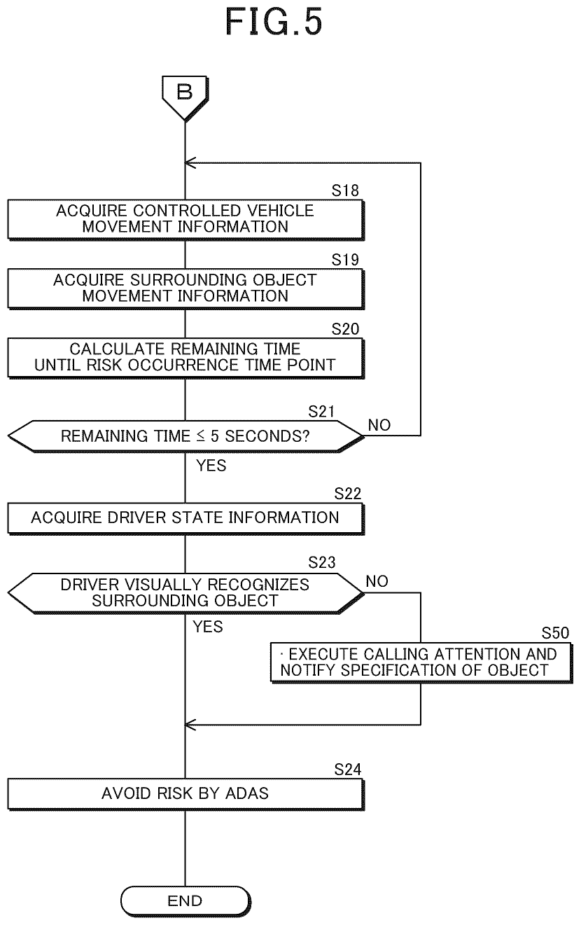

In step S16, the driver state recognition unit 14 acquires driver state information. Here, the driver state recognition unit 14 also recognizes a direction of a line of sight of the driver D from the captured image of the driver D by the driver's seat camera 45. In subsequent step S17, the calling attention control unit 15 determines whether or not the driver D visually recognizes the surrounding object from the direction of the line of sight of the driver D. When the driver D visually recognizes the surrounding object, the calling attention control unit 15 advances the processing to step S18 in FIG. 5, and in this case, the calling attention is not performed.

On the other hand, when the driver D does not visually recognize the surrounding object, the calling attention control unit 15 advances the processing to step S40, executes the calling attention for notifying dynamic point information (such as a blind spot of an oncoming vehicle at the time of turning right at an intersection to be described later), and advances the processing to step S18 in FIG. 5.

In step S18 of FIG. 5, the controlled vehicle movement information acquisition unit 11 acquires the controlled vehicle movement information, and in step S19, the surrounding object movement information acquisition unit 12 acquires the surrounding object movement information. In subsequent step S20, the calling attention control unit 15 calculates the remaining time until the risk occurrence time point based on the controlled vehicle movement information and the surrounding object movement information. In subsequent step S21, the calling attention control unit 15 determines whether or not the remaining time until the risk occurrence time point is less than 5 seconds. When the remaining time is less than 5 seconds, the calling attention control unit 15 advances the processing to step S22, and when the remaining time is 5 seconds or more, the calling attention control unit 15 advances the processing to step S18.

In step S22, the driver state recognition unit 14 acquires driver state information. Here, the driver state recognition unit 14 also recognizes a direction of a line of sight of the driver D from the captured image of the driver D by the driver's seat camera 45. In subsequent step S23, the calling attention control unit 15 determines whether or not the driver D visually recognizes the surrounding object from the direction of the line of sight of the driver D. When the driver D visually recognizes the surrounding object, the calling attention control unit 15 advances the processing to step S24, and in this case, the calling attention is not performed.

On the other hand, when the driver D does not visually recognize the surrounding object, the calling attention control unit 15 advances the processing to step S50, executes the calling attention for notifying specification of an object (such as a two-wheeled vehicle traveling straight at the time of turning right at an intersection to be described later), and advances the processing to step S24. In step S24, the ADAS control unit 16 appropriately executes control by the ADAS such as the collision reduction brake according to the distance between the self-vehicle 100 and the surrounding object recognized from the image captured by the front camera 40 and the position detection signal by the front radar 42.

### 4. Execution Example of Calling Attention

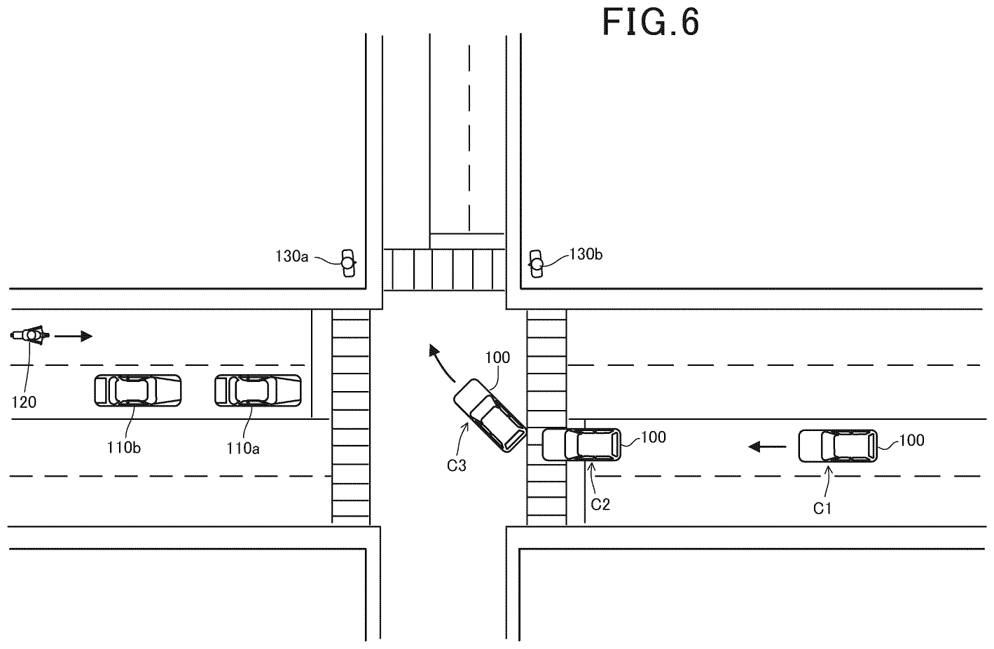

An aspect of the calling attention processing executed by the driving assistance apparatus 1 when the self-vehicle 100 turns right at an intersection will be described with reference to FIGS. 6 to 8. FIG. 6 illustrates a situation in which the self-vehicle 100 moves forward in the order of C1-C2-C3 and turns right at the intersection, and on an opposite lane, other vehicles 110a and 110b stop and the two-wheeled vehicle 120 travels straight. In addition, pedestrians 130a and 130b are present on a road after turning right.

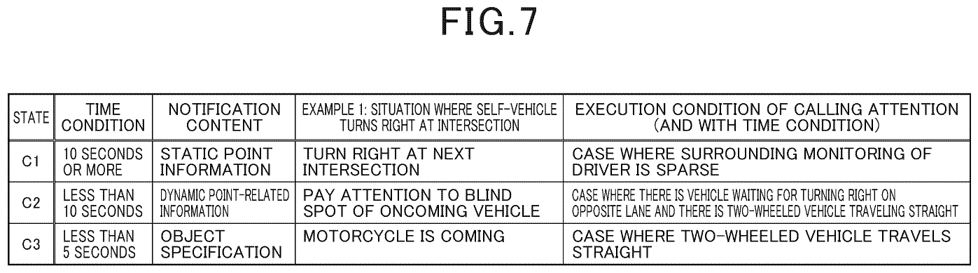

In the situation illustrated in FIG. 6, the calling attention control unit 15 executes the calling attention to the driver D of the self-vehicle 100 according to setting conditions illustrated in FIG. 7. In the situation illustrated in FIG. 6, the contact between the self-vehicle 100 and the two-wheeled vehicle 120 at the intersection is recognized as a predetermined risk, and a prediction time point at which the self-vehicle 100 and the two-wheeled vehicle 120 reach the intersection is predicted as a risk occurrence time point by the risk occurrence time point prediction unit 13.

In the setting conditions of FIG. 7, a weighting condition for determining whether or not to execute the calling attention is set by AND with a condition of a remaining time (10 seconds or more, less than 10 seconds, and less than 5 seconds) until the risk occurrence time point. That is, in a state of C1 where the remaining time is 10 seconds or more, the calling attention is executed in a “case where surrounding monitoring of the driver is sparse (case where the line of sight of the driver is not directed to the surrounding object)”. In addition, in a state of C2 where the remaining time is less than 10 seconds, the calling attention is executed in a “case where there is a vehicle waiting for turning right on the opposite lane and there is a two-wheeled vehicle traveling straight”. In addition, in a state of C3 where the remaining time is less than 5 seconds, the calling attention is executed in a “case where a two-wheeled vehicle travels straight”.

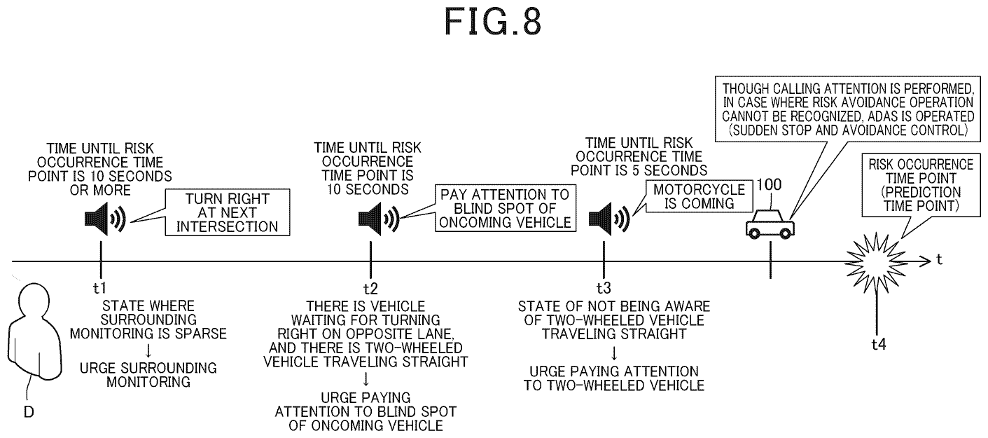

FIG. 8 illustrates a situation where the calling attention to the driver D of the self-vehicle 100 is executed according to the setting conditions of FIG. 7 with a time axis t. t1 to t3 are time points corresponding to C1 to C3 in FIGS. 6 and 7. In accordance with the transition of the remaining time until t4 to be the occurrence time point of the predetermined risk, calling attention “turn right at a next intersection” is performed at t1, calling attention “pay attention to a blind spot of an oncoming vehicle” is performed at t2, and calling attention “a motorcycle is coming” is performed at t3.

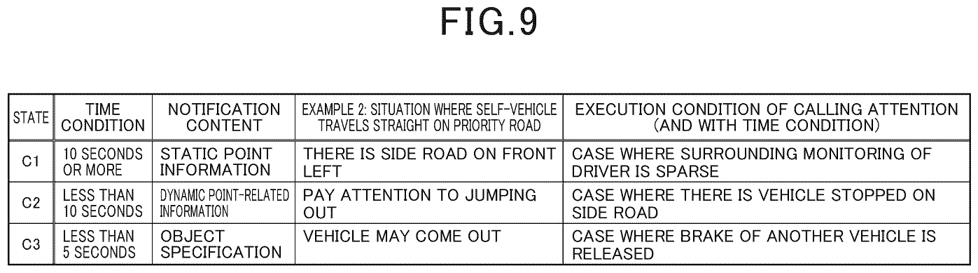

Next, FIG. 9 illustrates setting conditions for calling attention corresponding to a situation where the self-vehicle 100 travels straight on a priority road. In this case, the contact between the self-vehicle 100 and another vehicle at a connection point between the priority road and the side road is recognized as a predetermined risk, and a prediction time point at which the self-vehicle 100 reaches the connection point between the priority road and the side road is predicted as a risk occurrence time point by the risk occurrence time point prediction unit 13.

In the setting conditions of FIG. 9, a weighting condition for determining whether or not to execute the calling attention is set by AND with a condition of a remaining time (10 seconds or more, less than 10 seconds, and less than 5 seconds) until the risk occurrence time point. That is, in a state of C1 where the remaining time is 10 seconds or more, the calling attention is executed in a “case where surrounding monitoring of the driver is sparse (case where the line of sight of the driver is not directed to the surrounding object)”. In addition, in a state of C2 where the remaining time is less than 10 seconds, the calling attention is executed in a “case where a brake of another vehicle stopped on the side road is released”. The release of the brake of another vehicle stopped on the side road is recognized from surrounding object movement information for another vehicle.

### 5. Other Embodiments

In the above embodiment, when it is recognized that the line of sight of the driver D of the self-vehicle 100 is directed to the surrounding object, it is determined that the calling attention to the driver D is unnecessary. It may be determined that the driver D recognizes the surrounding object by other determination elements such as the following determination elements 1 to 3.

Determination element 1 . . . It is detected by the grip sensor 48 that the driver D grips the steering wheel, and it is detected by the pedal contact sensor 49 that the driver D puts the foot on the brake pedal.

Determination element 2 . . . In a case where it is grasped from the history of the image captured by the foot camera 44 that the driver D has a tendency to place the foot on the floor during normal driving and to step on the brake pedal immediately before, it is recognized that the driver D moves the foot from the floor to the brake pedal from the image captured by the foot camera 44.

Determination element 3 . . . Deceleration at a predetermined level or more is detected by the speed sensor 46 in response to the first calling attention (calling attention in step S30 of FIG. 3).

In the above embodiment, when it is recognized that the line of sight of the driver D of the self-vehicle 100 is directed to the surrounding object, it is determined that the calling attention to the driver D is unnecessary. As another embodiment, even in a case where it is recognized that the line of sight of the driver D of the self-vehicle 100 is directed to the surrounding object, when it is estimated that the attention of the driver D decreases based on the health state of the driver D recognized by the driver state recognition unit 14, the calling attention may be executed.

The decrease in the attention of the driver D is determined by estimating the stress, fatigue, mental state, and the like of the driver D based on the physical information of the driver D detected by the vital sensor 47 or the behavior of the driver D whose image is captured by the driver's seat camera 45, for example.

Note that FIGS. 1 and 2 are schematic diagrams illustrating the configurations of the vehicle 100 and the driving assistance apparatus 1 divided by main processing contents in order to facilitate understanding of the present invention, and the configurations of the vehicle 100 and the driving assistance apparatus 1 may be divided by other types. Further, the processing of each constituent element may be performed by a single hardware unit, or may be performed by a plurality of hardware units. Further, the processing of each constituent element shown in the flowcharts of FIGS. 3 and 4 may be executed by a single program or may be executed by a plurality of programs.

### 6. Configurations Supported by Above Embodiments

The above embodiments are specific examples of the following configurations.

(Configuration 1) A driving assistance apparatus includes: a controlled vehicle movement information acquisition unit configured to acquire controlled vehicle movement information including position information of a controlled vehicle; a surrounding object movement information acquisition unit configured to acquire surrounding object movement information including position information of a surrounding object present around the controlled vehicle; a risk occurrence time point prediction unit configured to predict a risk occurrence time point at which a predetermined risk occurs due to approaching of the controlled vehicle and the surrounding object, based on the controlled vehicle movement information and the surrounding object movement information; a driver state recognition unit configured to recognize a state of a driver of the controlled vehicle; and a calling attention control unit configured to determine execution timing of calling attention by a notification device provided in the controlled vehicle and contents of the calling attention, based on a remaining time until the risk occurrence time point and the state of the driver recognized by the driver state recognition unit.

According to the driving assistance apparatus of Configuration 1, it is possible to perform calling attention of the driver to the object present around the controlled vehicle (self-vehicle) at appropriate timing with appropriate contents.

(Configuration 2) The driving assistance apparatus according to Configuration 1, wherein the driver state recognition unit recognizes a direction of a line of sight of the driver as the state of the driver, the surrounding object movement information includes information indicating whether or not the controlled vehicle is recognized in the surrounding object, and the calling attention control unit executes the calling attention when it is determined that the controlled vehicle is not recognized in the surrounding object based on the surrounding object movement information, even in a case where it is recognized by the driver state recognition unit that the line of sight of the driver is directed to the surrounding object.

According to the driving assistance apparatus of Configuration 2, the controlled vehicle is not recognized in the surrounding object. Therefore, when the behavior of the surrounding object cannot be expected, even in a case where the driver of the controlled vehicle visually recognizes the surrounding object, the calling attention to the driver is performed, so that an effect of preventing the occurrence of the predetermined risk can be enhanced.

(Configuration 3) The driving assistance apparatus according to Configuration 1 or 2, wherein the calling attention control unit increases a level of the calling attention as the remaining time until the predetermined risk occurrence time point decreases.

According to the driving assistance apparatus of Configuration 3, it is possible to cause the driver of the controlled vehicle to recognize that the possibility of occurrence of the predetermined risk is increased, and to urge the driver to deal with the risk avoidance.

(Configuration 4) The driving assistance apparatus according to any one of Configurations 1 to 3, wherein the driver state recognition unit recognizes a driving state of the controlled vehicle by the driver as the state of the driver, and the calling attention control unit does not execute the calling attention when it is determined that the driver is capable of avoiding the predetermined risk from the driving state of the controlled vehicle by the driver recognized by the driver state recognition unit.

According to the driving assistance apparatus of Configuration 4, it is possible to avoid causing the driver to feel annoyed by performing the calling attention when the driver takes measures to avoid the predetermined risk.

(Configuration 5) The driving assistance apparatus according to any one of Configurations 1 to 4, wherein the driver state recognition unit recognizes a health state of the driver and the direction of the line of sight of the driver, and when it is recognized by the driver state recognition unit that the line of sight of the driver is directed to the surrounding object, the calling attention control unit determines whether or not to perform the calling attention according to the health state of the driver recognized by the driver state recognition unit.

According to the driving assistance apparatus of Configuration 5, when there is a concern about a decrease in cognitive ability of the driver due to the health state of the driver (stress, fatigue, mental state, and the like), it is possible to enhance an effect of preventing the occurrence of the predetermined risk by performing the calling attention to the driver even when the line of sight of the driver is directed to the surrounding object.

(Configuration 6) A driving assistance method executed by a computer, the driving assistance method including: a controlled vehicle movement information acquisition step of acquiring controlled vehicle movement information including position information of a controlled vehicle; a surrounding object movement information acquisition step of acquiring surrounding object movement information including position information of a surrounding object present around the controlled vehicle; a risk occurrence time point prediction step of predicting a risk occurrence time point at which a predetermined risk occurs due to approaching of the controlled vehicle and the surrounding object, based on the controlled vehicle movement information and the surrounding object movement information; a driver state recognition step of recognizing a state of a driver of the controlled vehicle; and a calling attention control step of determining execution timing of calling attention by a notification device provided in the controlled vehicle and contents of the calling attention, based on a remaining time until the risk occurrence time point and the state of the driver recognized by the driver state recognition unit.

By executing the driving assistance method of Configuration 6 by the computer, it is possible to obtain functions and effects similar to those of the driving assistance apparatus of Configuration 1.

(Configuration 7) A non-transitory recording medium storing a program that causes a computer to function as: a controlled vehicle movement information acquisition unit configured to acquire controlled vehicle movement information including position information of a controlled vehicle; a surrounding object movement information acquisition unit configured to acquire surrounding object movement information including position information of a surrounding object present around the controlled vehicle; a risk occurrence time point prediction unit configured to predict a risk occurrence time point at which a predetermined risk occurs due to approaching of the controlled vehicle and the surrounding object, based on the controlled vehicle movement information and the surrounding object movement information; a driver state recognition unit configured to recognize a state of a driver of the controlled vehicle; and a calling attention control unit configured to determine execution timing of calling attention by a notification device provided in the controlled vehicle and contents of the calling attention, based on a remaining time until the risk occurrence time point and the state of the driver recognized by the driver state recognition unit.

The driving assistance apparatus of Configuration 1 can be realized by causing the computer to execute the program of Configuration 7.

### REFERENCE SIGNS LIST

1 Driving assistance apparatus
10 Processor
11 Controlled vehicle movement information acquisition unit
12 Surrounding object movement information acquisition unit
13 Risk occurrence time point prediction unit
14 Driver state recognition unit
15 Calling attention control unit
16 ADAS control unit
20 Memory
21 Program
30 Communication unit
31 Vehicle control device
32 Navigation device
33 GNSS sensor
34 Map data
40 Front camera
41 Rear camera
42 Front radar
43 Rear radar
44 Foot camera
45 Driver's seat camera
46 Speed sensor
47 Vital sensor
48 Grip sensor
49 Pedal contact sensor
50 Display
51 Speaker
52 Seat vibration device
100 Controlled vehicle (self-vehicle)
110, 120 Other vehicle
200 Communication network
210 Traffic information server
D Driver

What is claimed is:

1. A driving assistance apparatus comprising:
a controlled vehicle movement information acquisition unit configured to acquire controlled vehicle movement information including position information of a controlled vehicle;
a surrounding object movement information acquisition unit configured to acquire surrounding object movement information including position information of a surrounding object present around the controlled vehicle;
a risk occurrence time point prediction unit configured to predict a risk occurrence time point at which a predetermined risk occurs due to approaching of the controlled vehicle and the surrounding object, based on the controlled vehicle movement information and the surrounding object movement information;
a driver state recognition unit configured to recognize a state of a driver of the controlled vehicle; and
a calling attention control unit configured to determine execution timing of calling attention by a notification device provided in the controlled vehicle and contents of the calling attention, based on a remaining time until the risk occurrence time point and the state of the driver recognized by the driver state recognition unit.

2. The driving assistance apparatus according to claim 1, wherein
the driver state recognition unit recognizes a direction of a line of sight of the driver as the state of the driver,
the surrounding object movement information includes information indicating whether or not the controlled vehicle is recognized in the surrounding object, and
the calling attention control unit executes the calling attention when it is determined that the controlled vehicle is not recognized in the surrounding object based on the surrounding object movement information, even in a case where it is recognized by the driver state recognition unit that the line of sight of the driver is directed to the surrounding object.

3. The driving assistance apparatus according to claim 1, wherein
the calling attention control unit increases a level of the calling attention as the remaining time until the predetermined risk occurrence time point decreases.

4. The driving assistance apparatus according to claim 1, wherein
the driver state recognition unit recognizes a driving state of the controlled vehicle by the driver as the state of the driver, and
the calling attention control unit does not execute the calling attention when it is determined that the driver is capable of avoiding the predetermined risk from the driving state of the controlled vehicle by the driver recognized by the driver state recognition unit.

5. The driving assistance apparatus according to claim 1, wherein
the driver state recognition unit recognizes a health state of the driver and the direction of the line of sight of the driver, and
when it is recognized by the driver state recognition unit that the line of sight of the driver is directed to the surrounding object, the calling attention control unit determines whether or not to perform the calling attention according to the health state of the driver recognized by the driver state recognition unit.

6. A driving assistance method executed by a computer, the driving assistance method comprising:
a controlled vehicle movement information acquisition step of acquiring controlled vehicle movement information including position information of a controlled vehicle;
a surrounding object movement information acquisition step of acquiring surrounding object movement information including position information of a surrounding object present around the controlled vehicle;
a risk occurrence time point prediction step of predicting a risk occurrence time point at which a predetermined risk occurs due to approaching of the controlled vehicle and the surrounding object, based on the controlled vehicle movement information and the surrounding object movement information;
a driver state recognition step of recognizing a state of a driver of the controlled vehicle; and
a calling attention control step of determining execution timing of calling attention by a notification device provided in the controlled vehicle and contents of the calling attention, based on a remaining time until the risk occurrence time point and the state of the driver recognized by the driver state recognition step.

7. A non-transitory recording medium storing a program that causes a computer to function as:
a controlled vehicle movement information acquisition unit configured to acquire controlled vehicle movement information including position information of a controlled vehicle;
a surrounding object movement information acquisition unit configured to acquire surrounding object movement information including position information of a surrounding object present around the controlled vehicle;
a risk occurrence time point prediction unit configured to predict a risk occurrence time point at which a predetermined risk occurs due to approaching of the controlled vehicle and the surrounding object, based on the controlled vehicle movement information and the surrounding object movement information;
a driver state recognition unit configured to recognize a state of a driver of the controlled vehicle; and
a calling attention control unit configured to determine execution timing of calling attention by a notification device provided in the controlled vehicle and contents of the calling attention, based on a remaining time until the risk occurrence time point and the state of the driver recognized by the driver state recognition unit.
